(19) United States
(12) Patent Application Publication
(10) Pub. No.: US 2009/0174901 A1
(43) Pub. Date: Jul. 9, 2009

(54) IMAGE FORMING DEVICE, IMAGE FORMING METHOD, AND IMAGE FORMING PROGRAM

(75) Inventors: Kei Shigehisa, Amagasaki-shi (JP); Takeshi Morikawa, Takarazuka-shi (JP); Nobuo Kamei, Osaka-shi (JP); Takeshi Minami, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc, Chiyoda-ku (JP)

(21) Appl. No.: 12/349,573

(22) Filed: Jan. 7, 2009

(30) Foreign Application Priority Data
Jan. 8, 2008 (JP) 2008-001516

(51) Int. Cl. G06F 15/00

(52) U.S. Cl. 358/1.15

(57) ABSTRACT

There is provided an image forming device that executes a job, being prescribed processing regarding image data, with execution of the job of this image data restricted by a password set in the image data. The image forming device includes: a password input unit that inputs the password necessary for releasing a restriction of executing the job; a password receiving unit that receives input password information, being information regarding the inputted password; a job execution instruction receiving unit that receives a job execution instruction after the password receiving unit receives the input password information; and a password verification unit that receives the job execution instruction and verifies the inputted password with a password set in the image data, wherein the job is executed by using the job image data based on a verification result of the password verification unit.

This application is based on an application No. 2008-001516 filed in Japan, the contents of which are hereby incorporated by reference.

### BACKGROUND OF THE INVENTION

1. Field of the Invention

The present invention relates to an image forming device, and particularly relates to the image forming device in which an input of a password is requested to a user, and according to the inputted password, prescribed processing is executed.

2. Description of the Related Art

Along with a development of a network technology in recent years, an image forming device, for example, a digital multifunction peripheral has been utilized in such a manner as being shared by a plurality of users connected by a network in many cases. Here, the digital multifunction peripheral (MultiFunction Peripheral (MFP), Scan Print Copy (SPC), or All In one (AIO)) indicates the image forming device having at least two or more functions of a copier, a printer, a scanner, facsimile equipment, and so forth.

When an instruction of image forming processing is given to the digital multifunction peripheral (called simply multifunction peripheral hereafter.), the user gives the instruction of processing the multifunction peripheral by using an apparatus connected to the multifunction peripheral via the network and located at a place away from the multifunction peripheral body, instead of inputting an instruction to the multifunction peripheral body first hand.

Therefore, when a document is printed on a paper medium, etc, by the multifunction peripheral based on the instruction received from the user, an outputted printed matter is exposed to human eyes if it is left on a paper eject tray of the multifunction peripheral. In such a case, there is a possibility that the printed matter is unexpectedly handed to an outsider. Such an event is a problem from a viewpoint of ensuring security of information.

JP 2005-051796 A discloses an image forming device capable of solving the aforementioned problem concerning ensuring security. By this image forming device, it is possible to realize a security management against leakage and storage of the information accumulated in a storage device.

This image forming device includes a section that sets a password for created image information, and a section that requests an input of the password when the instruction of printing and deleting the image information is inputted.

With this structure, the image forming device prevents the accumulated image information from being leaked and being unintentionally erased.

JP 2003-145889 A also discloses an image forming device. Even when a printout instruction is given by inputting a true password, this image forming device requests the input of the password for starting printout to the user again, in consideration of a waiting time until a resultant matter of this print processing is outputted from the printer. Therefore, even when the image information for printout is inputted in the image forming device, this image forming device inhibits the printout of this information, until the password for starting printout is inputted.

This image forming device can be set so that the printout is not started until the password for starting the printout is inputted by the user, thus making it possible to collect a printed matter without allowing an outsider to peek at this printed matter.

Thus, it is a generally performed event to set the password to ensure the security of the printed matter.

However, in the above-described conventional image forming device, in order to obtain the printed matter, the user must give the instruction of printout to the image forming device first by using an apparatus (for example located at a place away from the image forming device body), and thereafter the user must further input the password into the image forming device body.

Accordingly, the above-described conventional image forming device needs to hold data related to the printout within this data storage area, until the password is inputted after the printout instruction is given. Therefore, duration, in which the data related to the printout occupies the data storage area of the image forming device, is prolonged. Therefore, some countermeasure is necessary, such as enlarging the data storage area of the image forming device more than conventional from the viewpoint of a design of the image forming device.

In addition, in the above-described image forming device, for example, when the password is set in each page of a printed-out document including a plurality of pages, or when the password is set in each one of a plurality of printed-out documents, the user must input a plurality of passwords to the image forming device body first hand. Further, in executing a job, the image forming device sometimes has duration in which an operation necessary for printout is stopped, until correct input of the password is confirmed, thus prolonging the duration from giving the printout instruction by the user up to completion of the printout. In order to cope with such a circumstance, it is desired from the viewpoint of the user, to shorten the duration from giving the printout instruction by the user to the image forming device, up to the completion of the printout as much as possible and improve productivity of an image forming work at an office, etc.

### SUMMARY OF THE INVENTION

An object of the present invention is to provide an image forming device capable of suppressing consumption of a hardware resource, particularly capable of suppressing occupancy of the data storage area such as a working memory to minimum, and improving the productivity of the image forming work, while ensuring the security equivalent to that of a conventional image forming device.

First aspect of the present invention is an image forming device that executes a job, being prescribed processing regarding image data, with execution of the job of this image data restricted by a password set in the image data. The image forming device includes: a password input unit that inputs the password necessary for releasing a restriction of executing the job; a password receiving unit that receives input password information, being information regarding the password inputted for releasing the restriction of executing the job; a job execution instruction receiving unit that receives a job execution instruction for giving an instruction of starting the execution of the job to the image forming device, after the password receiving unit receives the input password information; and a password verification unit that receives the job execution instruction and verifies the inputted password with a password set in the image data, wherein the job is executed by using the job image data based on a verification result of the password verification unit.

Second aspect of the present invention is an image forming method in an image forming device that executes a job, being prescribed processing regarding image data, with execution of the job of the image data restricted by a password set in the image data. The image forming method includes: receiving input password information, being the information of inputted password for releasing a restriction of executing the job; receiving job execution instruction for giving an instruction of starting execution of the job after the step of receiving the input password information; receiving the job execution instruction and verifying the inputted password with a password set in the image data; and executing the job by using the job image data based on a verification result of the password verification.

Third aspect of the present invention is a computer-readable medium storing a program that can be executed by the computer, which is the program for making the computer execute image formation, the computer constituting an image forming device that executes a job, being prescribed processing regarding image data, with execution of the job of the image data restricted by a password set in the image data. The program includes: code that receives input password information, being the information of the password inputted for releasing a restriction of executing the job; code that receives a job execution instruction for giving an instruction of starting the execution of the job after receiving the input password information; code that receives the job execution instruction and verifying the inputted password with a password set in the image data; and code that makes the image forming device execute the job by using the job image data based on a verification result of the password verification.

In order to ensure the security, the image forming device of the present invention is capable of setting the password for the printout, and capable of starting the printout after the input of this password is confirmed. Therefore, the image forming device of the present invention is a preferable image forming device from the viewpoint of ensuring the security. Further, it is possible to shorten the duration from the input of the password by the user up to completion of the printout than the above-described conventional image forming device. Therefore, usability is improved for the user, and the duration of holding the image data for printout is shortened for the image forming device.

The image forming device of the present invention exhibits effects of improving use efficiency of the hardware resource of the image forming device, and improving the productivity of the image forming work performed by the user, while ensuring the security equivalent to that of the conventional image forming device.

### BRIEF DESCRIPTION OF THE DRAWINGS

The above and further objects and novel features of the invention will more fully appear from the following detailed description when the same is read in connection with the accompanying drawings, and in which:

FIG. 1 is a schematic diagram of an image forming system according to an embodiment of the present invention;

FIG. 2 is a perspective view of a MFP 1 according to another embodiment of the present invention;

FIG. 3 is a block diagram of a hardware structure of the MFP 1;

FIG. 4 is a block diagram of a structure of the MFP 1 viewed from a functional viewpoint;

FIG. 5 is a flowchart of printout processing of a confidential document of the MFP 1;

FIG. 6 is an example diagram of a user interface;

FIG. 7 is a diagram of the structure of confidential document information;

FIG. 8 is a flowchart of execution of a job of the MFP 1;

FIG. 9A is a diagram of a display example of a display 12 of the MFP 1;

FIG. 9B is a diagram of the display example of a user interface 71;

FIG. 10 is a diagram comparing the processing in the present invention with the processing in a conventional example regarding a processing time;

FIG. 11A is an example diagram of a document printed matter embedded with confidential document information;

FIG. 11B is an example diagram of the document printed matter embedded with the confidential document information;

FIG. 11C is an example diagram of the document printed matter embedded with the confidential document information;

FIG. 12 is a flowchart of confidential document scan processing of the MFP 1;

FIG. 13 is a diagram of a display example of the display 12 of the MFP 1;

FIG. 14 is a flowchart of executing the job of the MFP 1;

FIG. 15A is a diagram of the display example of the display 12 of the MFP 1;

FIG. 15B is a diagram of the display example of the display 12 of the MFP 1;

FIG. 16 is a diagram of the display example of the display 12 of the MFP 1; and

FIG. 17 is a diagram comparing the processing in the present invention with the processing in the conventional example regarding the processing time.

It is to be expressly understood, however, that the drawings are for the purpose of illustration only and are not intended as definitions of the limits of the invention.

### DETAILED DESCRIPTION OF THE PREFERRED EMBODIMENTS

Preferred embodiments of the present invention will be explained hereunder, with reference to the appended drawings.

<Structure>

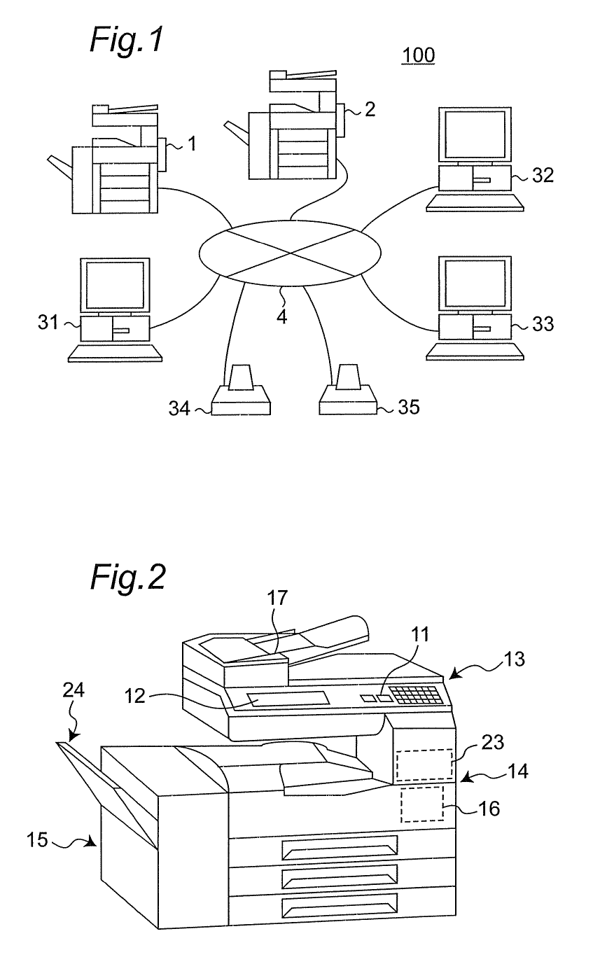

FIG. 1 is a schematic diagram of an image forming system 100 according to an embodiment of the present invention.

The image forming system has one or more multifunction peripherals (MFP) 1, 2, one or more personal computers (PC) 31, 32, 33, one or more facsimile terminals (FAX) 34, 35, and a network 4 mutually communicatively connecting the MFP(1, 2), PC(31, 32, 33), and FAX(34, 35). Each one of the MFP 1 and 2 constitutes the image forming device of the present invention. The network 4 is constituted of a network such as a local area network (LAN) or the Internet, or the network 4 may be constituted of a private communication line or a public communication line.

The MFP 1, 2, and PC 31, 32, 33 have apparatus identifying information within the network 4. The apparatus identifying information may be information specific to each apparatus and capable of specifying an exclusive apparatus based on the apparatus identifying information. The apparatus identifying information may have the names such as “PC001”, “PC002, “PC003” for each one of the PC 31, 32, 33. The same thing can be applied for the MFP 1, 2. Also, instead of the aforementioned names, it is also possible to use an Internet protocol address (IP address) as the apparatus identifying information. In addition, telephone numbers for a telephone network such as a so-called fixed-line phone and an Internet protocol phone (IP phone) are given to each one of the FAX 34, 35.

FIG. 2 is a perspective view of an outer appearance of the MFP 1.

The MFP 1 serves as the image forming device intensively provided with a copy function, a printer function (including network printing), a scanner function, a facsimile function, and a document server function, etc. It may be possible to set the MFP 1 so as to inhibit the user from using the MFP 1 when the user does not succeed in user authentication based on user information registered in an authentication server, etc, located in the MFP 1 or outside the MFP 1 and connected by the network 4, this user can not use the MFP 1.

The MFP 1 includes:

an operation unit 11 used in an input of an instruction, etc, by a user;

a display 12 that presents information to the user, etc;

a scanner unit 13 that photoelectrically reads image information of a paper medium, etc;

a printer unit 14 that prints the image information on the paper medium, etc;

a finisher unit 15 that ejects a printed paper medium;

a communication interface 16 that performs transmission/reception of the information to/from an external device via the network 4;

a document feeder 17 that sequentially feeds the paper medium, etc, to the scanner unit 13;

a sheet feeder (not shown) that feeds the paper medium to the printer unit 14;

a central processing unit (CPU) (not shown) that controls an operation of the MFP 1; and

a random access memory (RAM) (not shown), read only memory (ROM) (not shown), a data storing unit 23, etc, that hold a program or data, etc.

The operation unit 11 includes:

key buttons for inputting numbers, characters, and symbols, etc, into the MFP 1;

a sensor for recognizing press-down of each key button; and

a transmission circuit that transmits to the CPU a signal shown by the key button whose press-down is recognized by the sensor.

The display 12 displays:

a screen for providing a message or an instruction to the user;

a screen for inputting contents of the setting and processing by the user; and

a screen for displaying an image formed by the MFP 1 or a result of the image forming processing, etc.

In the MFP 1 according to this embodiment, the display 12 serves as a touch panel. The display 12 has a function of detecting a location touched by the user on the display 12, and sending a detection result to the CPU, and constitutes a part of the operation unit 11.

The operation unit 11 and the display 12 constitute a user interface for directly operating the MFP 1. Meanwhile, an application program or a driver program for inputting the instruction to the MFP 1 are installed in the PC 31, 32, or 33 (FIG. 1). The user can remotely control the MFP 1 by operating the PC 31, 32 or 33.

The scanner unit 13 can generate the image data by photoelectrically reading the image information such as photographs, characters, pictures. The image data here is the data regarding density of the image. This image data is sent to an image processing unit (not shown), converted to digital data in the image processing unit, then subjected to each kind of known image processing and sent to the printer unit 14 and the communication interface 16, and is used for a print of the image or data transmission. Also, the digital data is sometimes stored in the data storing unit 23 for utilization thereafter.

The printer unit 14 prints the image data read by the scanner unit 13, the image data received from the external device by the communication interface 16 via the network 4 (FIG. 1), and the digital data stored in the data storing unit 23, and so forth, in a recording medium such as a paper medium or a film medium. The sheet feeder 18 (not shown) is provided in a lower part of the MFP 1 body, and feeds the recording medium suitable for the printout to the printer unit 14.

The finisher unit 15 includes a stapler that performs staple processing to the paper medium, or a puncture that performs puncture processing to the paper medium, and so forth. The recording medium after executing print processing by the printer unit 14, namely a printed matter is subjected to the staple processing and puncture processing according to a print mode setting in the finisher unit 15, and is ejected to a tray 24.

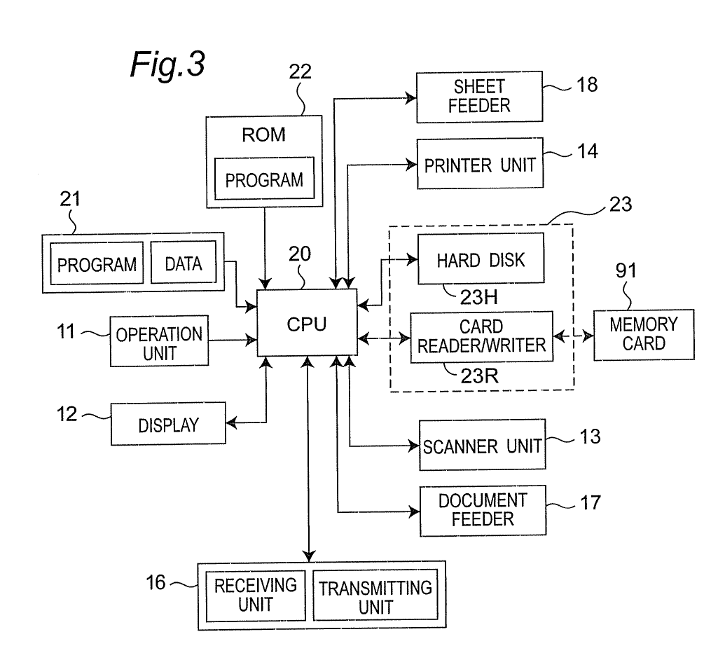

FIG. 3 is a block diagram showing a hardware structure of the MFP 1.

The communication interface 16 includes a transmitting unit that transmits data to the external device and a receiving unit that receives the data from the external device. The MFP 1 can transmit/receive the data to/from the PC 31, 32, 33 (FIG. 1) and the FAX 34, 35 (FIG. 1) through the communication interface 16. A network interface card (NIC), a modem, a terminal adapter (TA), or the like, is given as examples of the communication interface 16.

The data storing unit 23 holds the program and data, etc. The data storing unit 23 includes a hard disk 23H and a card reader/writer 23R.

The card reader/writer 23R can read data or write data from/into a memory card 91 such as a compact flash (registered trademark), smart media (registered trademark) (SmartMedia (SM) or Solid State Floppy Disk Card (SSFDC)). By using the memory card 91, transmission/reception of data to/from the external device (such as PC 31, 32, 33) is possible not through the network 4. Also, by using the memory card 91, backup of the data in the MFP 1 is possible.

The hard disk 23H has an area for storing the digital data obtained by reading by means of the scanner unit 13, the digital data received from outside through the communication interface 16, and the data regarding the history of executed image processing (job) (job mode history). Also, the external device can refer to the digital data stored in the hard disk 23H through the communication interface 16.

<Functional structure>

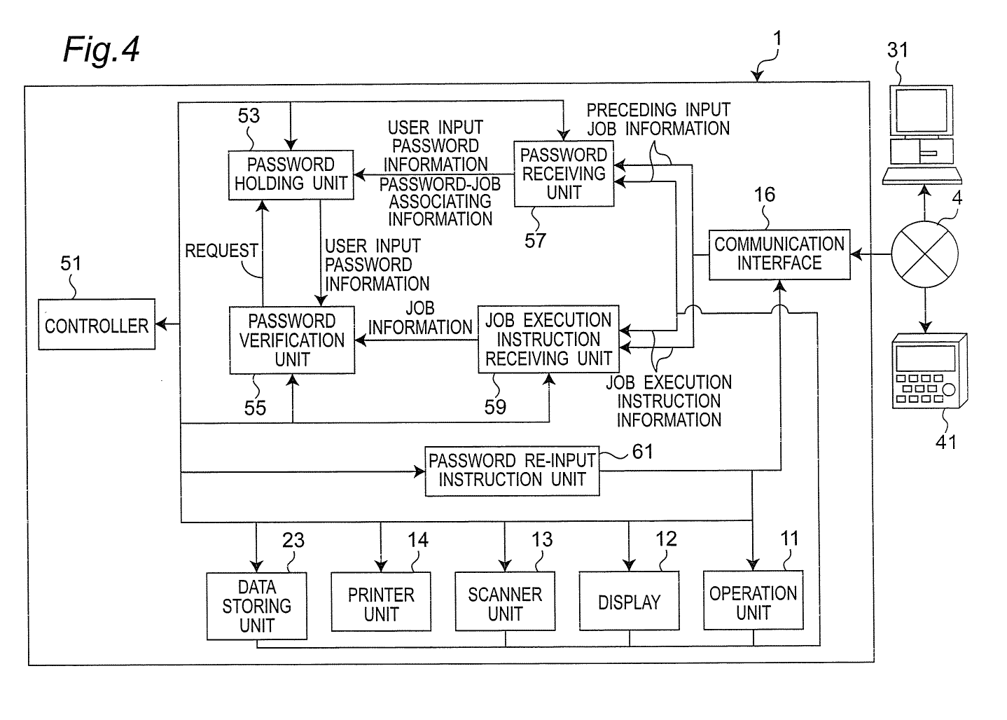

FIG. 4 is a diagram of the structure of the multifunction peripheral (MFP) 1 from a functional viewpoint. The function of each block is realized by a program stored in RAM 21 or ROM 22, or the data storing unit 23 and is read and executed by the CPU 20, and each constituent element of the multi function peripheral 1 shown in FIG. 3. In addition, it may be also possible to provide a functional block realized by a dedicated hardware circuit. However, the functional block not directly related to the present invention is not shown in FIG. 4.

The MFP 1 executes a job, being prescribed processing (such as print processing) for the image data. At that time, the execution of this job can be restricted by the password directly set in this image data or the password stored in the MFP 1 or an external server in association with this image data. This password can be set in each page of the document including this image data or in an entire body of the document. Upon executing the job, the MFP 1 can interrupt the execution of the job protected by the password as described above, until the password is inputted from the outside. In addition, when a false password is inputted, the MFP 1 can execute prescribed processing such as automatically discarding this job.

The MFP 1 includes a controller 51, a password holding unit 53, a password verification unit 55, a password receiving unit 57, a job execution instruction receiving unit 59, a password re-input instruction unit 61, and so forth.

The controller 51 controls the operation of the MFP 1.

The password receiving unit 57 receives preceding input job information from the communication interface 16 and the operation unit 11, etc. The preceding input job information can include user input password information, being the information regarding the password inputted by the user, and password-job associating information, being the information regarding the association between the password inputted by the user and the job. The password-job associating information includes the name of a data file selected by the user for this job, and job ID number given to the job specifically, or the like. The password inputted by the user includes one or more passwords, necessary for executing the job concerning the job execution instruction included in job execution instruction information as will be described later. This preceding input job information will be explained in detail later.

The password holding unit 53 receives the user input password information and the password-job associating information, etc, from the password receiving unit 57, and stores them in this storing unit 53.

Meanwhile, the job execution instruction receiving unit 59 receives the job execution instruction information from the communication interface 16 and the operation unit 11, and so forth. The job execution instruction information can include, for example, the job execution instruction inputted by the user, such as the press-down of a “start button” of the operation unit 11 or the press-down of an “OK button” displayed on the PC 31. In addition, the job execution instruction information can include the job information, being the information regarding the job concerning the job execution instruction inputted by the user. The job execution instruction information and the job information will also be explained in detail later.

The MFP 1 receives the preceding input job information before receiving the job execution instruction information, and starts the execution of the job, following the job execution instruction information received later. This is because the preceding input job information includes the password-job associating information and therefore it is possible to process the job execution instruction information received later and the user input password information in association with each other. With this structure, the MFP 1 makes it possible to improve usability and save the hardware resource (for example, it is possible to shorten an occupancy time of the memory, etc, by a single job).

The password verification unit 55 receives the job information, etc, from the job execution instruction receiving unit 59, and based on this job information, sends a request requesting the user input password information from the password holding unit 53. Then, the password verification unit 55 acquires the user input password information from the password holding unit 53. The password verification unit 55 verifies the received job information with the user input password information, and determines true and false of the password inputted by the user.

When the password verification unit 55 determines that the password inputted by the user is “true”, the controller 51 executes the job concerning the job execution instruction information. When the password verification unit 55 determines that the password inputted by the user is “false”, under the control of the controller 51 using a password re-input instruction unit 61, the message prompting the user to re-input the password is displayed on the external PC 31 or a mobile terminal 41 connected through the communication interface 16, or the display 12.

The MFP 1 according to an embodiment of the present invention can receive one or more passwords necessary for executing the job, earlier than receiving the job execution instruction. Thus, the MFP 1 can complete the job, without a request of the password necessary for executing this job given to the user after the data necessary for executing the job concerning the job execution instruction is developed on a working memory (such as RAM 21 (FIG. 3)). Accordingly, in the MFP 1 according to the embodiment of the present invention, even when the job is executed with the security ensured by the password, the occupancy time of the hardware resource such as the memory (for example, RAM 21 (FIG. 3)) can be suppressed to minimum. In addition, when viewed from the user side, in the MFP 1 according to the embodiment of the present invention, the password can be inputted before the job execution instruction is sent to the MFP 1 from not only the operation unit 12 but also a remote PC 31 or a remote mobile terminal 41 connected by a network. This makes it possible to improve the usability.

<Job execution example>

The processing for executing the job by the MFP 1 will be explained hereafter.

### JOB EXECUTION EXAMPLE 1

### Printout Processing of a Confidential Document

A flow up to the printout of a confidential document protected by the password will be explained. Here, the confidential document is stored in the PC 31 (FIG. 4), as a digital data file protected by, for example, a password. The data file of the confidential document can include the data showing the document body and the information regarding the document. The information regarding the document includes, for example, the information regarding created date, password, and processing at the time of disagreement of the password. Note that the information regarding this document may be stored in the data storing unit 23 by the MFP 1. In this case, the data file of the confidential document can omit the information regarding the document. Based on the file name of the data file, the MFP 1 can read the information regarding the corresponding document from the data storing unit 23.

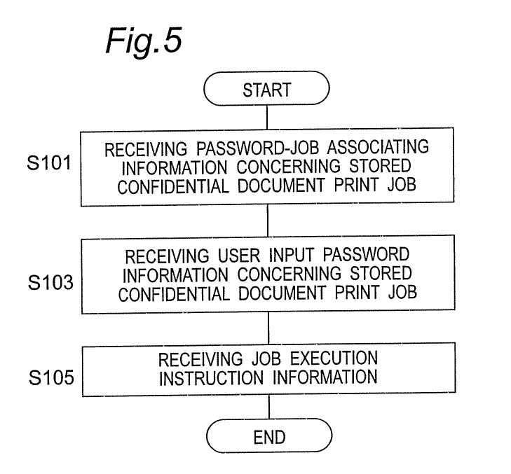

FIG. 5 is a flowchart showing the flow of the processing up to the start of the printout of the confidential document by the MFP 1.

In connection with step S101 and step S103, the user sets items necessary for executing the printout job such as designating the data file of the confidential document concerning the printout of the confidential document, in the PC 31 or the mobile terminal 41 (FIG. 4), and inputs the password necessary for this printout job.

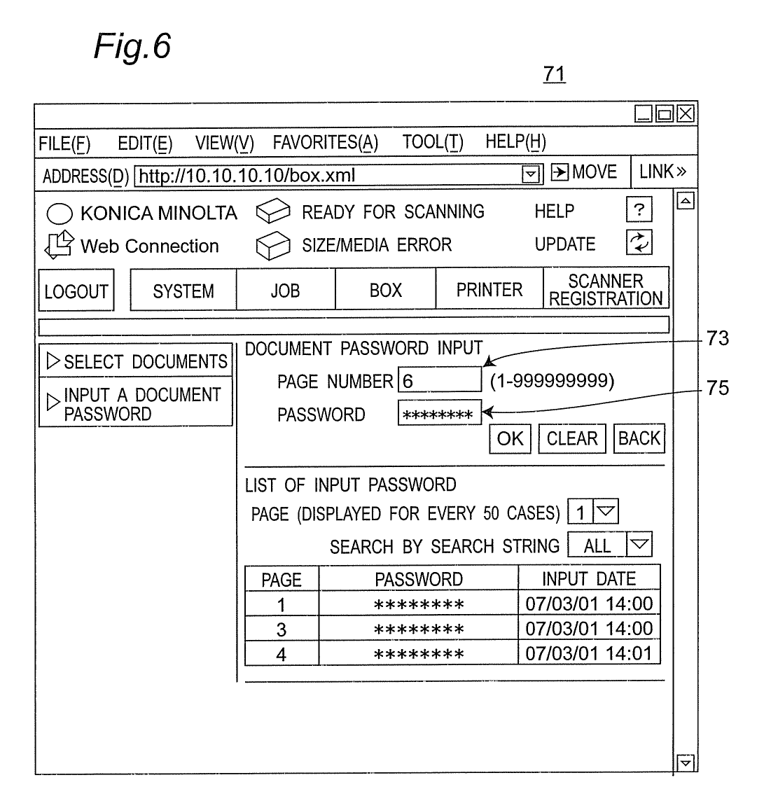

FIG. 6 is an example diagram of a user interface 71 used in the input of the password by the user. The user interface 71 is realized by a web browser executed on the PC 31 or the mobile terminal 41. The user interface 71 has a screen for prompting the user to input the password necessary for executing this printout job. This screen has a text box 75 for inputting the password by the user. In addition, when the password is set in each page, this screen has a text box 73 for showing the page of the confidential document corresponding to the inputted password. Although the display of the page number in this text box 73 may be automatically performed, it is also possible to change the display by inputting the number by the user. Note that although the example of the user interface 71 is realized by a general-purpose information processing apparatus and a general-purpose web browser, dedicated terminal equipment for inputting the password may also be used. This dedicated terminal equipment is connected to the MFP 1 via the network 4.

In FIG. 5 again, in step S101, the password receiving unit 57 (FIG. 4) of the MFP 1 receives the item necessary for executing the aforementioned printout job from the PC 31 through the network 4. The item necessary for this printout job includes the password inputted by the user, and the password-job associating information, being the information for associating the password inputted by the user with the job execution instruction of this printout job.

In step S103, the password receiving unit 57 of the MFP 1 receives the password necessary for the aforementioned printout job from the PC 31 or the mobile terminal 41 through the network 4 as the user input password information.

The password receiving unit 57 of the MFP 1 receives the password-job associating information (step S101) and the user input password information (step S103) as the preceding input job information, and the password holding unit 53 of the MFP 1 holds the preceding input job information (user input password information and the password-job associating information).

In connection with step S103, the device into which the user inputs the password, may be the same as the device used in setting the item necessary for the printout job by the user, or may be a different device.

Thus, according to the present invention, the user can input the password necessary for the printout job, at an arbitrary timing before the job execution instruction is inputted from the device remotely disposed from the MFP 1, for example, which is different from the operation unit 11 of the MFP 1 body. By inputting the password from the device disposed remotely from the MFP 1, at an arbitrary timing before the job execution instruction is inputted, the user can previously input the password at an arbitrary timing before the job execution instruction is inputted, without inputting the password to the MFP 1 first hand, and can input only the job execution instruction at a timing when the printed matter is actually desired to be outputted from the MFP 1 to extract the printed matter from the MFP 1. Thus, the user can acquire the printed matter in a shorter time than conventional, after the job execution instruction is inputted. Note that the password may be inputted simultaneously with the setting of the item necessary for the printout job in step S101, or may be performed at other timing. In the latter case, the input of the password-job associating information into the MFP 1 (step S101) and the input of the user input password information into the MFP 1 (step S103) are performed at substantially different times. In this case, the MFP 1 can manage the password-job associating information and the user input password information received at different times, so as to be collected into one as the preceding input job information.

In connection with step S105, the user inputs the job execution instruction of this printout job in the pc 31, the mobile terminal 41, or the dedicated terminal equipment (not shown), or the operation unit 11 of the MFP 1. The input of this job execution instruction may be performed in the same device as any one of the devices used by the user in connection with step S101 and step S103, or may be a different device.

In step S105, the job execution instruction receiving unit 59 (FIG. 4) of the MFP 1 receives the aforementioned job execution instruction from the PC 31, the mobile terminal 41, or the dedicated terminal equipment (not shown), or the operation unit 11 of the MFP 1. At this time, the PC 31 that stores the data file of the confidential document sends this data file to the MFP 1 as the job information. Note that when the user inputs the job execution instruction in the device other than the PC 31 that stores the data file of the confidential document, it may be preferable that the MFP 1 that receives the job execution instruction sends the request requesting the data file, to the PC 31 that stores the data file necessary for this job, and the PC 31 sends this data file to the MFP 1 in response to this request.

The MFP 1 receives and holds the job execution instruction and the job information as the job execution instruction information. When the job execution instruction information is received, the MFP 1 starts the execution of the job concerning this job execution instruction information.

Note that the MFP 1 is also capable of storing the data file of the confidential document in this data storing unit 23. When the confidential document stored in the MFP 1 is printed-out, the image data of this confidential document may be omitted from the job information. Instead, document associating information such as the information regarding a storage location of this confidential document in the MFP 1 may be included in the job information. The MFP 1 develops the image data necessary for the printout on the memory (RAM 21 or the data storing unit 23) based on the document associating information.

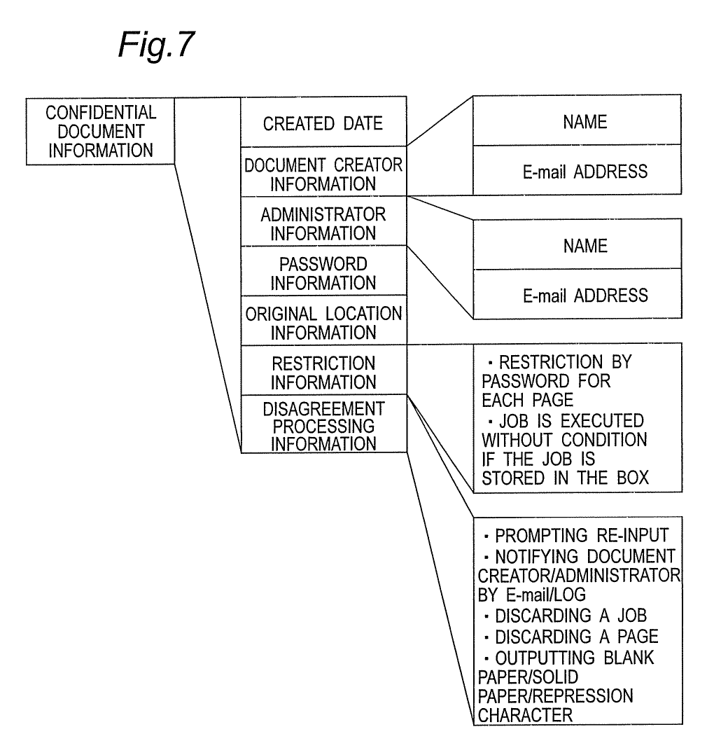

FIG. 7 is a diagram of a constitutional example of the information regarding the document included in the data file of the confidential document. Note that as described above, the information regarding this document can be held in the data storing unit 23 of the MFP 1.

The information regarding the document (confidential document information) includes:

created date indicating the date and time when the data file of this document is created;

document creator information indicating a person who creates the data file of this document;

administrator information who manages the MFP 1;

password information indicating the password set in this document;

original location information indicating a location (storage place) of original data of the data file of this document;

restriction information indicating restriction of the processing, etc, applied to this document; and

disagreement processing information indicating the processing in a case of a disagreement of the password.

The document creator information includes the name of a document creator and an e-mail address. Also, the document creator information may include the information regarding other notifying means.

The administrator information includes the name of a administrator of the MFP 1 and the e-mail address. Also, the administrator information may be held in the MFP 1 separately from the information regarding the document.

The restriction information is related to the password information and includes the information regarding the setting of the password, whether the password is set in each page or the password is set in each job, or the password is set in each job kind. According to the setting of the password in the example of FIG. 7, the password is not set for the job only for storing this data file within the MFP 1. Note that the restriction information may be held within the MFP 1.

The disagreement processing information includes the information for designating the processing when the password inputted by the user does not agree with the password shown by the password information. This processing can include, for example, contents of the processing such as prompting the re-input of the password, notifying the document creator or the administrator of the password disagreement by e-mail or log, discarding the job concerning the disagreement of the password, discarding the page concerning the disagreement of the password, and outputting blank paper/solid paper/repression character.

Note that the restriction information and the disagreement information may be held in the MFP 1, without storing them in the confidential document as the information regarding the document.

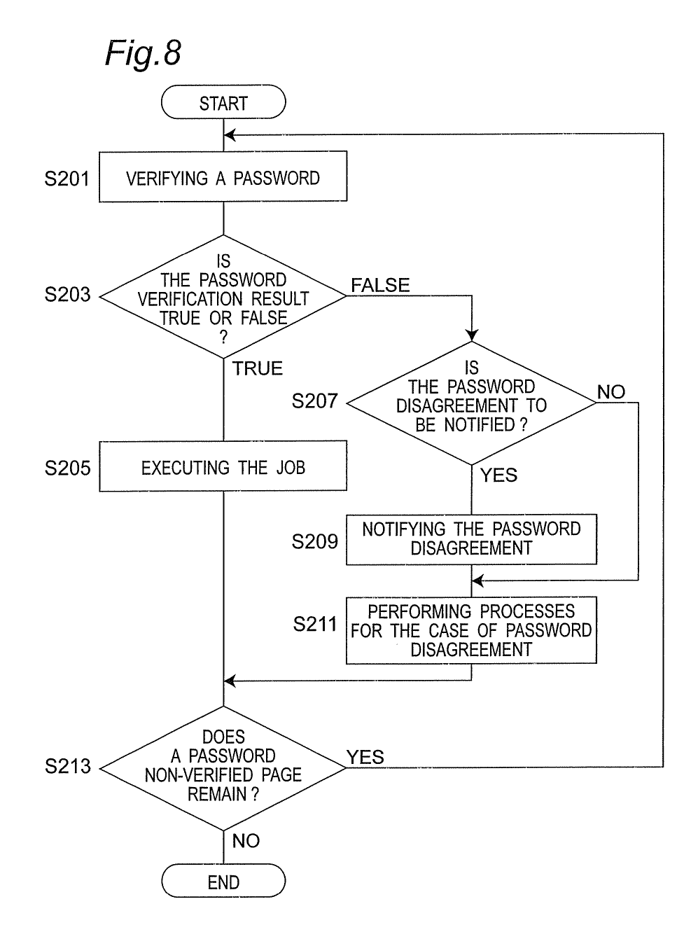

FIG. 8 is a flowchart of the processing regarding the execution of the job in the MFP 1.

In step S201, the password verification unit 55 of the MFP 1 receives the job information (including the confidential document information or the document associating information in the data file of the confidential document) from the job execution instruction receiving unit 59, and requests the user input password information from the password holding unit 53 based on the confidential document information in the data file of the confidential document acquired based on this confidential document related information or the document associating information. Then, the password verification unit 55 verifies the acquired user input password information with the password information included in the confidential document information.

In step S203, the password verification unit 55 determines true/false of the password inputted by the user. When this determination result shows “true” (“TRUE” in step S203”), the processing is advanced to step S205. When the determination result shows “false” (“FALSE” in step S203”), the processing is advanced to step S207.

In step S205, the MFP 1 executes the job set by the user, for the confidential document protected by the password set to be “TRUE” in step S203, or for the page in this document.

In step S207, the MFP 1 determines whether or not the occurrence of the matter such as “disagreement of the password” should be notified to the creator or the administrator by e-mail or log based on the restriction information or the disagreement information of the confidential document information. When the MFP 1 so determines that this disagreement should be notified (when determined to be “YES” in step S207), the processing is advanced to step S209. When the MFP 1 so determines that this disagreement should not be notified (when determined to be “NO” in step S207), the processing is advanced to step S211.

In step S209, the MFP 1 performs the processing of notifying the occurrence of the matter such as “disagreement of the password”, to a set person (the creator or the administrator), by set means (e-mail or log)

In step S211, the MFP 1 performs the processing in the case of the occurrence of password disagreement, to the job which is being executed. The contents of the processing here follow the disagreement processing information of the confidential document information.

For example, when the re-input of the password is set as the processing in the case of the occurrence of the password disagreement, the password re-input instruction unit 61 of the MFP 1 displays the message of prompting the re-input of the password on at least either one of the application (such as the web browser) that can be executed by the device connected to the MFP 1 through the network 4 such as the PC 31 and the mobile terminal 41 (FIG. 4), the dedicated terminal equipment, and the display 12 of the MFP 1. Here, the number of times of the re-input may be restricted, like the re-input of the password is restricted to three times. In addition, thumbnail display or preview display may be performed to notify the user so as to be easy to understand with which page the password disagrees.

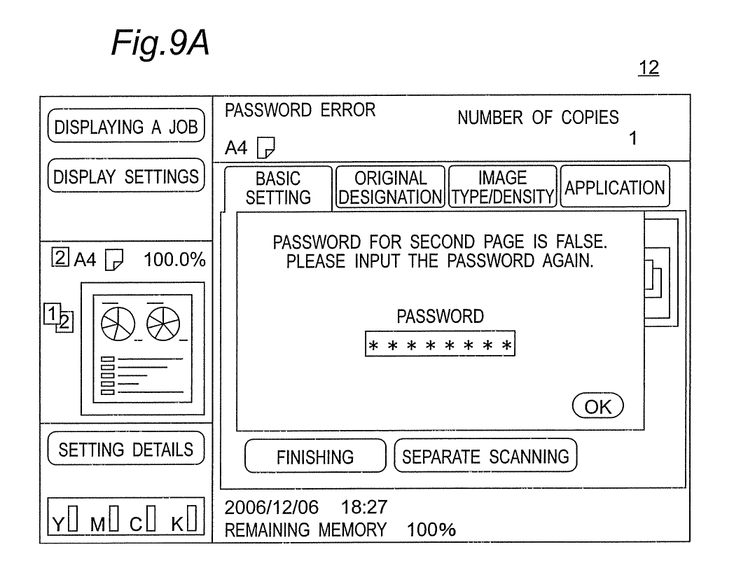

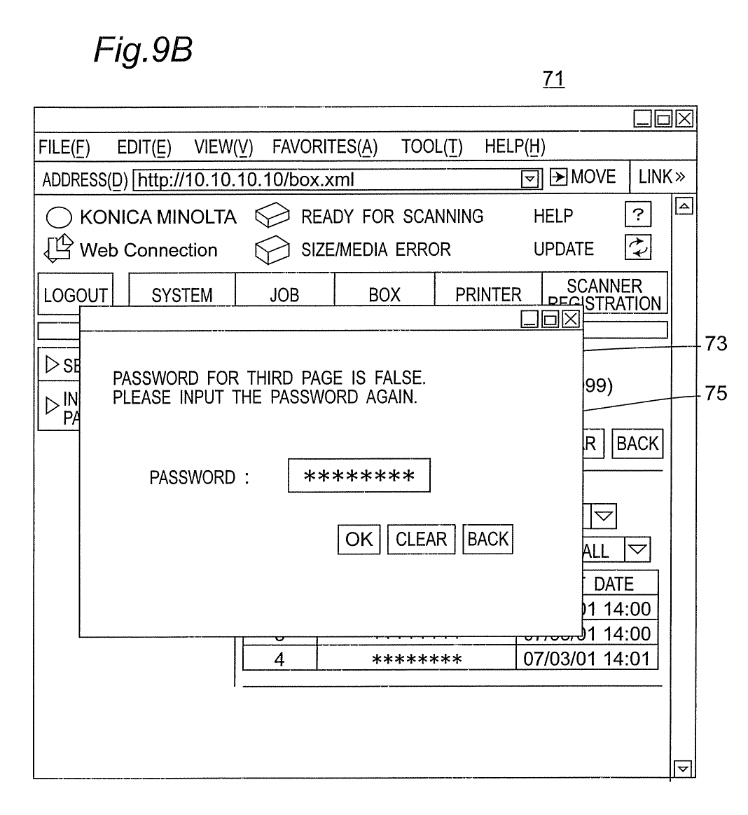

FIG. 9A and FIG. 9B are views showing examples of the display of the message concerning the re-input of the password.

FIG. 9A shows an example of a display of the message displayed on the display 12 of the MFP 1. The user who receives this display may input the password concerning the designated page from the operation unit 11 of the MFP 1.

FIG. 9B shows an example of the display of the message realized by the web browser operating on the PC 31. The user who receives this display may input the password concerning the designated page by using a keyboard, etc, of the PC 31, for example.

Such a processing of the re-input of the password may be constituted so that a loop of the processing that returns to step S201 through step S213 as will be described later, is executed for all pages of the confidential document concerning the job, and thereafter re-inputs of the password concerning the password disagreement are collectively requested to the user.

As another example of the processing in step S211, it may also be preferable that the processing of deleting the job or the page concerning the password disagreement from a working memory of the MFP 1 may be performed, or instead of the printout of the page of the confidential document, the blank paper/solid paper/repression character may be outputted. This repression character notifies the user of the message that output is suppressed because of the protection by the password. Here, it is advantageous to perform the processing of deleting the data from the working memory, from the viewpoint of efficient utilization of the hardware resource, because the occupancy area of the memory is partially opened from this point.

In addition, when executing the job set as the job not requesting the input of the password in the restriction information, etc, (such as the job only for storing the data file in the MFP 1, explained in details of the aforementioned restriction information), the job may be executed in step S211, instead of step S205, even when the password disagreement occurs.

In step S213, whether or not there is a page not completing the verification of the password is determined. When there is the page not completing the verification of the password (“YES” in step S213), the processing is returned to step S201. When there is no page not completing the verification of the password (“NO” in step S213), the processing is ended.

Note that in step S201 returned from step S213, when the same password as the already verified password is set for an object to be verified, the processing skips step S201 and step S203, and may be advanced to step S205.

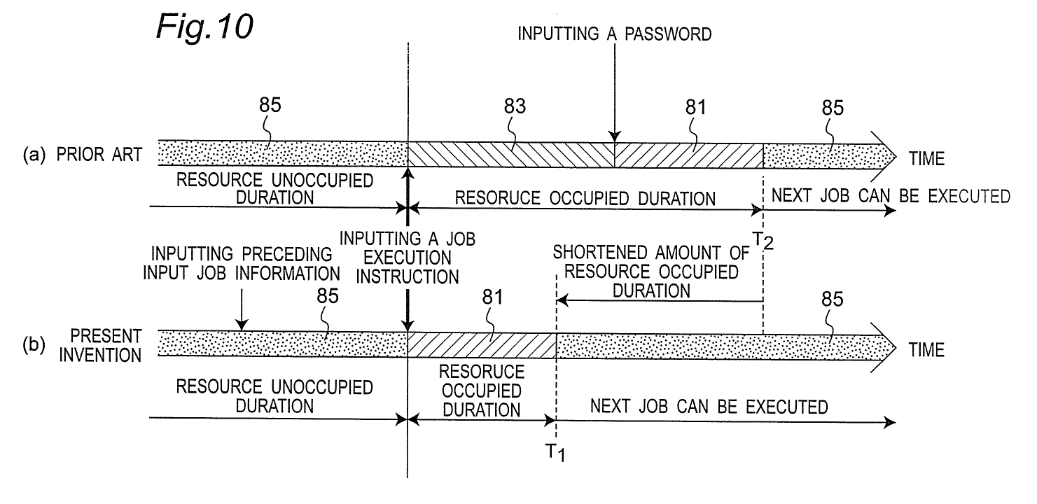

FIG. 10 is a view for comparing a conventional image forming device capable of executing a password setting job with the MFP 1 according to an embodiment of the present invention along a time line of executing the job.

The horizontal axis of this figure indicates the time axis. As shown in FIG. 10(b), in the MFP 1 according to the embodiment of the present invention, setting of the job and a required password are inputted in the MFP 1 as the preceding input job information. At this time, in the MFP 1, the hardware resource is not occupied by this job (resource unoccupied duration 85). Then, when the job execution instruction information is inputted in the MFP 1, the MFP 1 allocates the hardware resource to this job for the first time. Then, the MFP 1 executes this job instantaneously. The execution of the job is expressed as job execution duration 81 in the figure.

Meanwhile, in the conventional image forming device, as shown in FIG. 10(a), the hardware resource is occupied by this job, simultaneously with execution instruction of the job. Thereafter, the input of the password is performed. The waiting time from the execution instruction of the job up to the input of the password is expressed as duration 83 in the figure.

Thus, in the conventional image forming device, during the waiting time for the input of the password (during password waiting duration 83), at least a part of the hardware resource (for example, the working memory) is occupied by the data for this job (for example, image data) Therefore, the duration in which the hardware resource is occupied by this job corresponds to the sum of the duration 83 and the job execution duration 81. Meanwhile, in the MFP 1 according to the embodiment of the present invention, the duration in which the hardware resource is occupied by this job is only the time (duration 81) necessary for executing the job. Thus, in the present invention, the occupancy time of the hardware resource is shortened. In addition, job execution completion time of the present invention is earlier than that of the conventional image forming device when the input of the job execution instruction is set as a base point. This is the characteristic specific to the present invention that contributes to improving the usability.

In the confidential document printout processing of the MFP 1 according to the present invention, the user can previously input the password from the operation unit 11 of the MFP 1 or the device other than the operation unit 11, prior to the job execution instruction. The MFP 1 receives the job execution instruction information inputted thereafter, allocates the hardware resource to this job, and executes this job instantaneously. Therefore, if the job execution instruction is sent to the MFP 1 at a suitable timing for obtaining the printout from the MFP 1, the user can obtain the printout without waiting for the completion of the printout at a place near the MFP 1.

### JOB EXECUTION EXAMPLE 2

### Confidential Document Reading Processing

Next, explanation will be given for the flow of the processing for executing the job including the processing of photoelectrically reading the printed matter of the confidential document protected by setting the password from the scanner unit 13. Here, the processing of photoelectrically reading the information printed on the paper medium, etc, from the scanner unit 13 and generating the image data is called a “scanning job”. Note that the scanning job of the present invention is used commonly in the job of generating the digital data from the image data generated by the scanning job and storing it in the storing unit 23, the job of immediately performing the printout from the image data, and a so-called copy job, or the like. Also, the scanning job can be performed by utilizing an external scanner device, through the network 4.

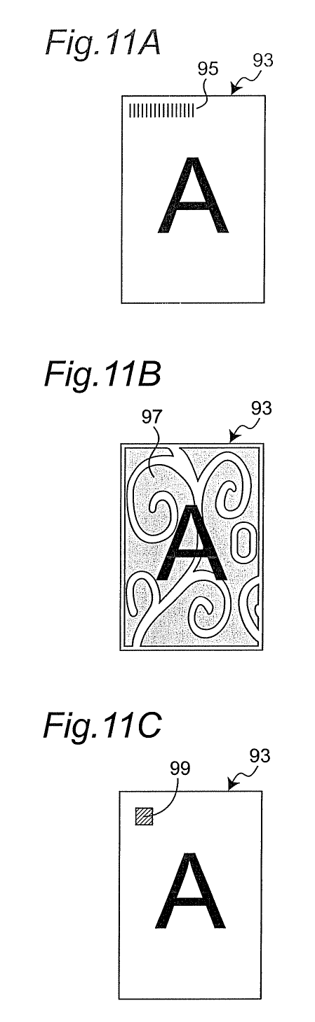

FIG. 11A, FIG. 11B, and FIG. 11C are views showing examples of invisibly embedding the confidential document information (FIG. 7) in a document printed matter.

FIG. 11A is an example diagram of a document printed matter 93 embedded with the confidential document information as a barcode 95. FIG. 11B is an example diagram of the document printed matter 93 embedded with the confidential document information as a background pattern 97. FIG. 11C is an example diagram of the document printed matter 93 embedded with the confidential document information as an IC tag (IC chip) 99. Thus, the confidential document information can be embedded in the printed matter of the confidential document, by means of the barcode 95, etc. When the confidential document information is embedded in the printed matter of the confidential document as the barcode 95 and the background pattern 97, the scanner unit 13 can read the barcode, etc, indicating the confidential document information, by performing a normal photoelectrical image reading. When the confidential document information is embedded in the printed matter of the confidential document as the IC tag 99, preferably the MFP 1 includes a sensor capable of reading the data electromagnetically stored in the IC tag 99.

Note that as exemplified in FIGS. 11A, 11B, 11C, the confidential document information may be embedded in the printed matter of the confidential document. However, as an alternative method, it may also be preferable that only ID number, etc, is embedded in the printed matter of the confidential document as the barcode, etc, then the confidential document information, etc, is held in the MFP 1 or other device, and based on the ID number, the confidential document information may be acquired by the MFP 1.

Also, the contents of the information included in the confidential document information may be equivalent to that shown in FIG. 7.

The password information included in each confidential document printed matter may be the password set for the page of this printed matter, or may be the password set for an entire body of the confidential document including this page of this printed matter.

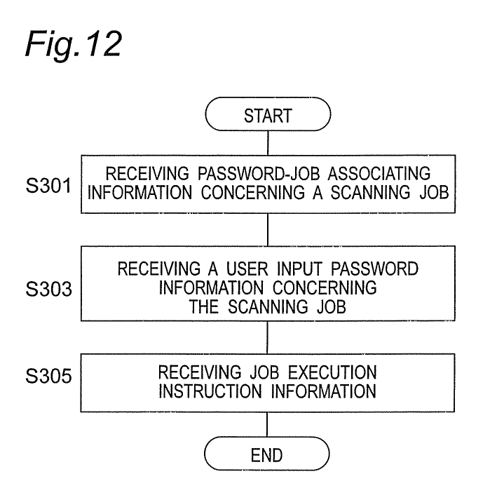

FIG. 12 is a flowchart showing the flow of the processing up to start of reading the confidential document printed matter by the MFP 1.

In connection with step S301 and step S303, the user sets the item necessary for the scanning job for the confidential document printed matter by using the operation unit 11 of the MFP 1 (FIG. 2), and inputs the password necessary for this scanning job.

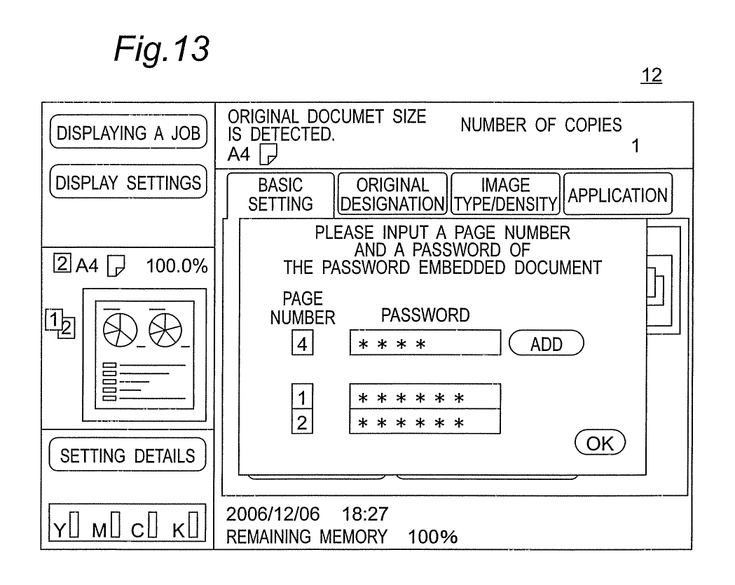

FIG. 13 is an example diagram of the display 12 used in the input of the password by the user. The display 12 displays the screen for inputting the password by the user, necessary for executing this scanning job. This screen includes a text box 175 for inputting the password by the user. In addition, when the password is set in each page of the confidential document printed matter, the text box 173 is provided for showing the page of the confidential document printed matter corresponding to the inputted password. The display of the page number in this text box 173 may be automatically performed, but can be changed by inputting the number by the user.

In FIG. 12 again, in step S301, the password receiving unit 57 of the MFP 1 (FIG. 4) receives set items necessary for executing this scanning job inputted from the operation unit 11. The set items include the password-job associating information, etc, being the information for associating the password inputted by the user and the job execution instruction of this scanning job.

Note that when the printed matter is detected to be placed on a document feeder 17 (FIG. 1), the password-job associating information may be automatically generated for associating the password inputted thereafter with the job for scanning the printed matter placed on the document feeder 17.

In step S303, the password receiving unit 57 of the MFP 1 receives the password necessary for executing this scanning job inputted from the operation unit 11 as the user input password information.

Note that in the same way as the aforementioned job execution example 1, the user may input the set items and the password necessary for the scanning job from the PC 31, etc, connected to the MFP 1 through the network 4. In such a case, the user may input the aforementioned set items and the aforementioned password simultaneously or may input them at other timing from another device. In the latter case, the user further inputs the information concerning the correspondence between the one which is previously inputted and the other one which is inputted thereafter, out of the aforementioned necessary set items and the aforementioned password.

In the same way as the job execution example 1, the password receiving unit 57 of the MFP 1 receives the password-job associating information (step S301) and the user input password information (step S303) as the preceding input job information, and the password holding unit 53 of the MFP 1 holds the preceding input job information (the user input password information and the password-job associating information).

In connection with step S305, the user inputs the job execution instruction of this scanning job, in the PC 31, the mobile terminal 41, or the exclusive terminal (not shown), or the operation unit 11 of the MFP 1. This job execution instruction may be inputted in any one the devices used by the user in connection with step S301 and step S303, or may be the different device.

In step S305, the job execution instruction receiving unit 59 of the MFP 1 (FIG. 4) receives the aforementioned job execution instruction from the PC 31, the mobile terminal 41, or the dedicated terminal equipment (not shown), or the operation unit 11 of the MFP 1. At this time, the MFP 1 starts scan of the printed matter placed on the document feeder 17, and receives the image data obtained by this scan as the job information. The MFP 1 holds the job execution instruction (including the image data obtained by scan) and the job information as the job execution instruction information.

Note that it is also possible that the MFP 1 stores the data file of the confidential document in this data storing unit 23, and based on the confidential document information embedded in each page of the scanned printed matter, acquires the data file including all pages of this confidential document, and executes the job thereafter for this data file.

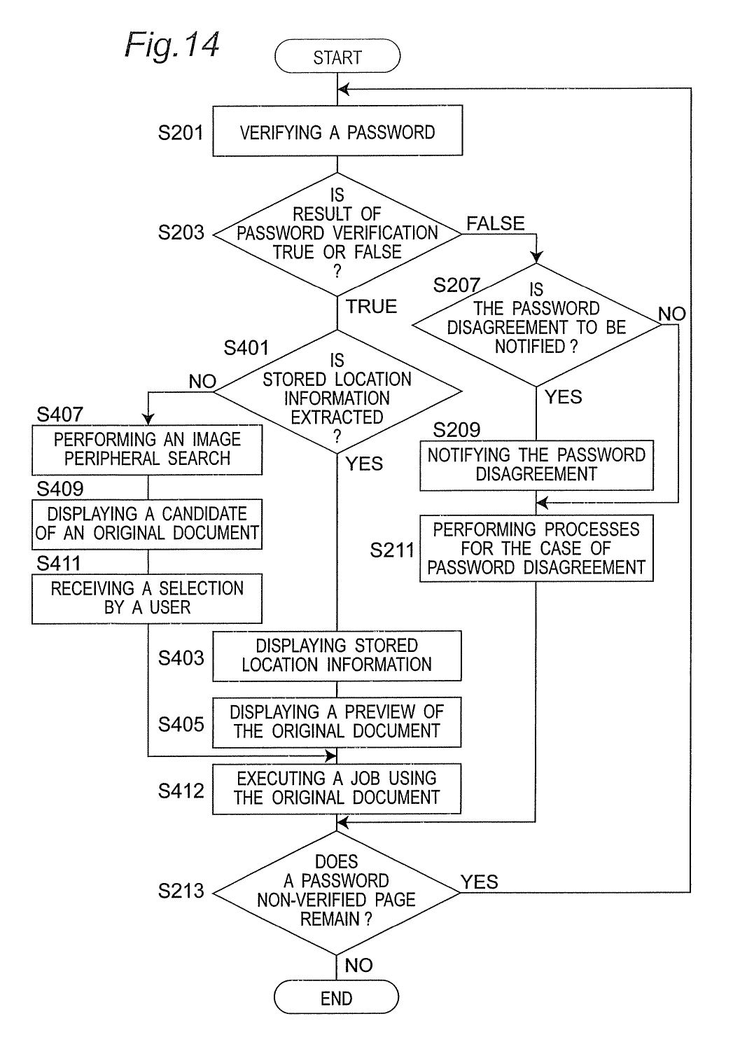

Next, explanation will be given for the flow of the processing after acquiring the image data by scan, with reference to FIG. 14. Note that step S201, step S203, step S207, step S209, step S211, and step S213 of the steps included in this figure are the same as the steps of the job execution example 1, and therefore the explanation therefore is omitted here. When the image data obtained by scan is stored or printed-out, storage processing or printout processing may be executed instead of the steps after step S401 of FIG. 14 as the processing in the case of “TRUE” of step S203.

The flow after step S401 is the flow showing an example of acquiring the data file including all pages of the confidential document based on the confidential document information embedded in each page of the scanned printed matter, and executing the job for this data file. In this case, the confidential document information includes the original location information shown in FIG. 7. Note that in the case of the job such as executing the flow after step S401, the password previously inputted by the user may be the password concerning the confidential document and also may be the password for accessing the storage area (called a “box”.) in which the data file of the confidential document is stored.

In step S401, the MFP 1 determines whether or not the original location information included in the confidential document information is extracted from the image data obtained by scan. When the original location information is extracted (“YES” in step S401), the processing is advanced to step S403. When the original location information is not extracted, the processing is advanced to step S407.

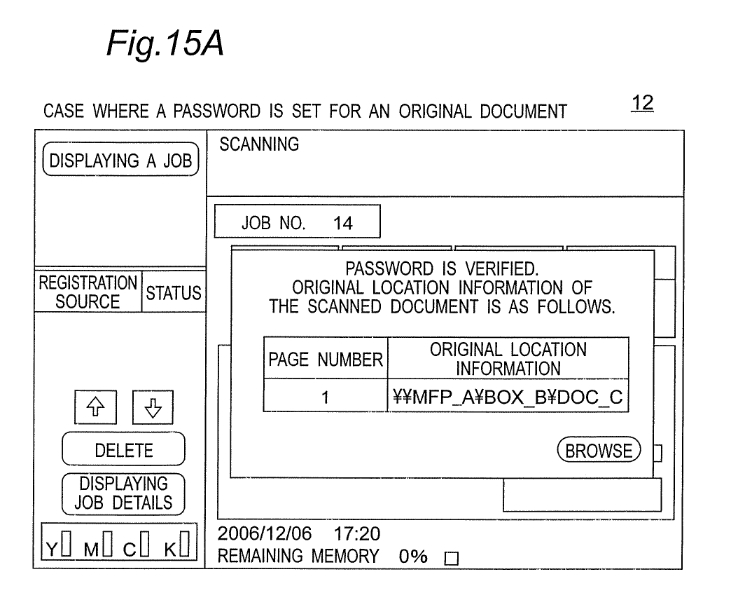

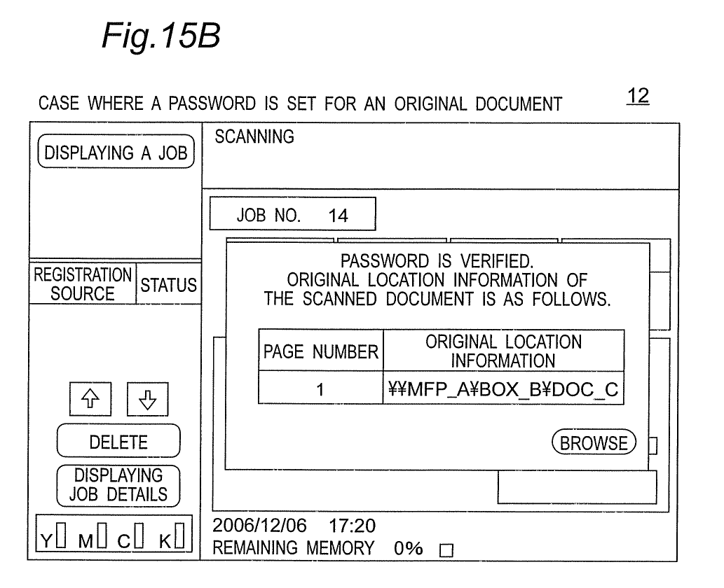

In step S403, the MFP 1 displays the original location information on the display 12. FIG. 15A is a display example of the original location information in the case of the agreement between the password set in the confidential document and the password inputted by the user. Also, FIG. 15B is the display example of the original location information in the case of the agreement between the password set in the box in which the data file of the confidential document is stored, and the password inputted by the user.

Then, in step S405, the MFP 1 displays a preview of the data file of the confidential document (original document) on the display 12.

Then, in step S412, the MFP 1 executes the job set by using the data file of the confidential document.

Note that when there is no data file corresponding to the storage area suggested by the original location information even if the original location information exists in the page of the scanned confidential document printed matter, the processing flow may be constituted so that the display 12 displays no original document in a prescribed box to discard this job.

In step S407, the MFP 1 executes image peripheral search.

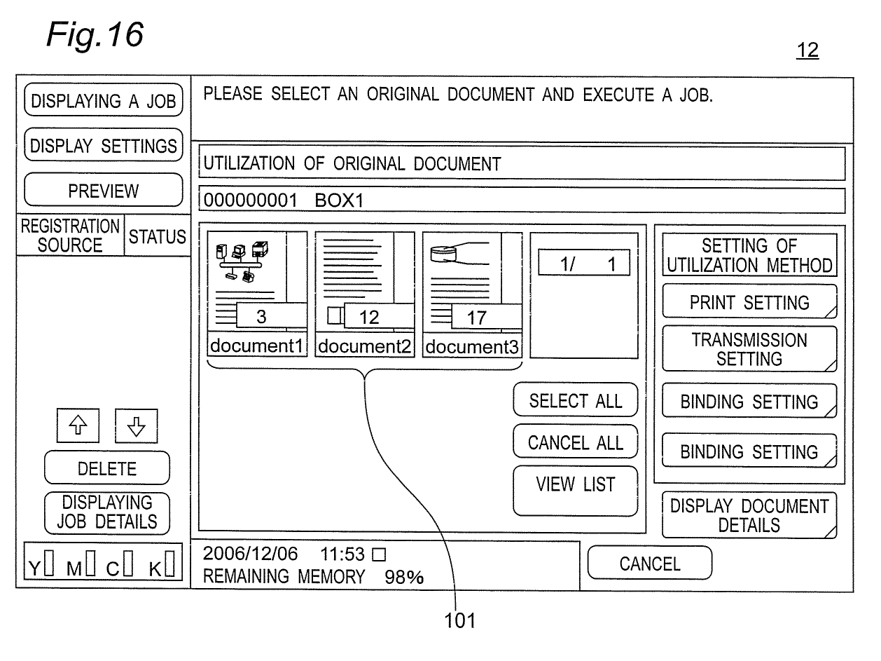

In step S409, the MFP 1 displays a candidate of the original document by using a result of the image peripheral search executed in step S407. FIG. 16 is the display example of the display 12 of the candidate of the original document. A preview image 101 of the data file given as the candidate of the original document is displayed on the display 12.

In step S411, the MFP 1 receives selection of the original document by the user, and based on this selection, executes a prescribed job in step S412.

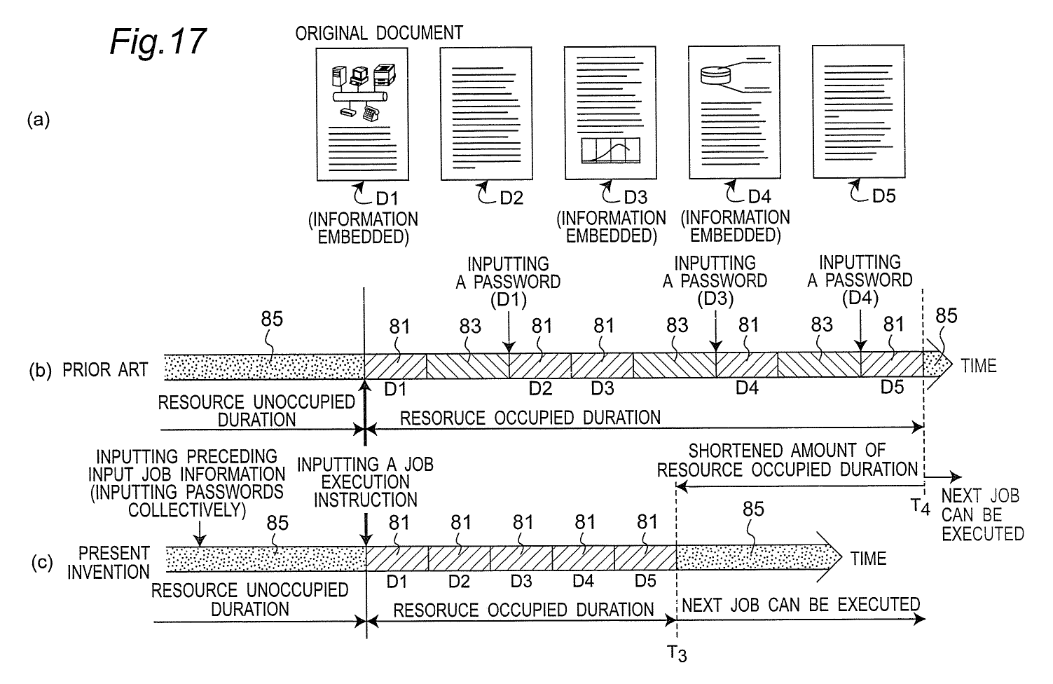

FIG. 17 is a diagram comparing the conventional image forming device capable of executing the password setting job, with the MFP 1 according to the embodiment of the present invention along the time line of the scanning job for a printed page of the confidential document whose password is already set.

As shown in FIG. 17(a), the job of sequentially scanning document printed pages D1, D2, D3, D4, and D5 is given as an example. Pages D1, D3, and D4 are the confidential document printed pages embedded with the confidential document information. The confidential document information included in these pages describes that the password is requested in executing the printout of each page. Meanwhile, the pages D2 and D5 are normal document printed pages not embedded with the confidential document information.

The horizontal axis of this figure indicates the time axis. As shown in FIG. 17(c), in the MFP 1 according the embodiment of the present invention, the setting of the job and one or more necessary passwords are collectively inputted in the MFP 1 as the preceding input job information. At this time, in the MFP 1, the hardware resource is not occupied by this job. Specifically, the hardware resource (such as the working memory (RAM 21) etc,) is not occupied by the image data obtained by scan (duration 85). Then, when the job execution instruction information is inputted in the MFP 1, the MFP 1 allocates the hardware resource to this job, for the first time. Specifically, in order to hold the scanned image data, the memory is secured. Then, the MFP 1 continues this job instantaneously based on the already inputted one or plurality of passwords. The execution of the job is expressed as the duration 81 in the figure.

Meanwhile, as shown in FIG. 17(b), in the conventional image forming device, the hardware resource is occupied by the job, simultaneously with the execution instruction of this job. Then, the password is inputted thereafter. The waiting time from the execution instruction of the job up to the input of the password is expressed as the duration 83 in the figure. Specifically, in the duration 83 after scanning the document D1, document D3, document D4, the password concerning each one of the document D1, document D3, and document D4 is requested.

Thus, in the conventional image forming device, the duration in which the hardware resource is occupied by the job corresponds to the sum of the duration 83 and the duration 81. Meanwhile, in the MFP 1 according to the embodiment of the present invention, the duration in which the hardware resource is occupied by the job is only the time (duration 81) necessary for executing this job. Thus, in the present invention, the occupancy time of the hardware resource is shortened. Also, the job execution completion time is earlier in the case of the present invention, when the input of the job execution instruction is set as the base point. This is the characteristic specific to the present invention and contributes to improving the usability.

Note that the present invention can also be implemented by constituting the scanner unit, the printer unit, and the controller of the present invention, by using a general-purpose information processing apparatus such as a scanner, a printer, a personal computer which are separately independently disposed, and the mobile terminal, and so forth.

Note that the program realizing the present invention may be stored in the storage device in the image processing apparatus. In addition, the aforementioned program can be circulated in a state of being held in the storage medium such as a flexible disc, an optical disc, a nonvolatile memory including USB memory. Further, the aforementioned program can be distributed via the network.

The present invention has an advantage of shortening the occupancy time of the hardware resource in the image forming device, and an advantage of improving the usability. The present invention is effective in a field of the image forming device.

As this invention may be embodied in several forms without departing from the spirit of essential characteristic thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image forming device that executes a job, being prescribed processing regarding image data, with execution of the job of this image data restricted by a password set in the image data, comprising:
a password input unit that inputs the password necessary for releasing a restriction of executing the job;
a password receiving unit that receives input password information, being information regarding the password inputted for releasing the restriction of executing the job;
a job execution instruction receiving unit that receives a job execution instruction for giving an instruction of starting the execution of the job to the image forming device, after the password receiving unit receives the input password information; and
a password verification unit that receives the job execution instruction and verifies the inputted password with a password set in the image data,
wherein the job is executed by using the job image data based on a verification result of the password verification unit.

2. The image forming device according to claim 1, further comprising a scanner unit that photoelectrically reads a printed matter and generates the image data,
wherein said scanner unit extracts confidential document information photoelectrically and readably embedded in the printed matter from the generated image data, and further extracts the information regarding the set password from the extracted confidential document information, and the job is executed by using the generated image data.

3. The image forming device according to claim 2, wherein the confidential document information is embedded in the printed matter as a barcode or a background pattern.

4. The image forming device according to claim 2, further comprising a sensor that electromagnetically reads the confidential document information included in an IC chip embedded in the printed matter, wherein the sensor extracts the information of the set password from the read confidential document information.

5. The image forming device according to claim 1, wherein:
said password input unit has a communication interface; and
said password receiving unit receives the input password information sent from an information processing apparatus that exists on a network connected via the communication interface.

6. The image forming device according to claim 2, wherein:
said password input unit has an operation unit capable of inputting the information; and
said password receiving unit receives input password information inputted via the operation unit.

7. The image forming device according to claim 6, wherein:
said scanner unit detects the printed matter placed thereon, and
said password receiving unit associates the input password information received when said scanner unit detects the printed matter placed thereon, with a job using an image of the printed matter placed on said scanner unit as the image data.

8. The image forming device according to claim 1, further comprising:
a communication interface;
a printer unit that prints-out image data; and
a data storing unit that stores the image data,
wherein the set password is the password for restricting at least one of: transmission of the image data via the communication interface; print of the image data using the printer unit; and storage of the image data into the data storing unit.

9. The image forming device according to claim 2, further comprising:
a data storing unit that stores a data file of a document,
wherein the set password is the password to restrict access to the data file of the document stored in the data storing unit.

10. The image forming device according to claim 1, wherein when the verification result of the password verification unit indicates disagreement of the password, the job using this image data is not executed, and the job image data is deleted.

11. The image forming device according to claim 1, wherein when the verification result of the password verification unit indicates the disagreement of the password in a case where the job executes printout, the job using the image data is not executed, and at least one of: blank paper; solid paper; and repression characters is printed-out.

12. The image forming device according to claim 1, wherein:
the job information includes at least one of: the information regarding a user who gives an execution instruction of the job; a user who creates the job image data; and a administrator of the image forming device; and
when the verification result of the password verification unit indicates disagreement of the password, the disagreement of the password is notified to at least one of: the user who gives the execution instruction; the user who creates the job image data; and the administrator.

13. The image forming device according to claim 1, further comprising:
a password re-input instruction unit that gives an instruction of re-input of the password necessary for executing the job,
wherein when the verification result of the password verification unit indicates disagreement of the password, the password re-input instruction unit outputs the information for prompting the re-input of the password necessary for executing the job.

14. The image forming device according to claim 1, further comprising:
a data storing unit that stores image data;
wherein when the verification result of the password verification unit indicates disagreement of the password in a case where the job is the job for storing the image data in the data storing unit, the job is executed irrespective of the disagreement of the password.

15. An image forming method in an image forming device that executes a job, being prescribed processing regarding image data, with execution of the job of the image data restricted by a password set in the image data, comprising:
receiving input password information, being the information of inputted password for releasing a restriction of executing the job;
receiving job execution instruction for giving an instruction of starting execution of the job after said receiving the input password information;
receiving the job execution instruction and verifying the inputted password with a password set in the image data; and
executing the job by using the job image data based on a verification result of the password verification.

16. A computer-readable medium storing a program, the program being for making the computer execute image formation, the computer constituting an image forming device that executes a job, being prescribed processing regarding image data, with execution of the job of the image data restricted by a password set in the image data, the program comprising:
code that receives input password information, being the information of the password inputted for releasing a restriction of executing the job;
code that receives a job execution instruction for giving an instruction of starting the execution of the job after receiving the input password information;
code that receives the job execution instruction and verifies the inputted password with a password set in the image data; and
code that makes the image forming device execute the job by using the job image data based on a verification result of the password verification.
